(19) United States
(12) Patent Application Publication
(10) Pub. No.: US 2018/0375868 A1
(43) Pub. Date: Dec. 27, 2018

(54) Equipment Control System

(71) Applicant: Three Diamond Capital Tech Co., LLC, Spring, TX (US)

(72) Inventor: Doug Vladmir Ticas, Rosenberg, TX (US)

(73) Assignee: Three Diamond Capital Tech Co., LLC, Spring, TX (US)

(21) Appl. No.: 15/697,785

(22) Filed: Sep. 7, 2017

Related U.S. Application Data
(60) Provisional application No. 62/522,845, filed on Jun. 21, 2017.

(51) Int. Cl. H04L 29/06

(52) U.S. Cl. CPC H04L 63/10; G06Q 30/0645

(57) ABSTRACT

The invention disclosed herein includes an equipment management system. The equipment management system can include an ignition control device for connecting to a vehicle, a network for transmitting data between the ignition control device and a computer device. The equipment management system can also include an administrator portal to access and manage the ignition control device, manage the equipment management system, and have the capability to grant access and control to branch offices and customers.

### CLAIM OF PRIORITY

This non-provisional utility patent application hereby claims priority to previously filed provisional application titled “Equipment Control System” filed on Jun. 20, 2017 (Application No. 62/522,845).

### BACKGROUND OF INVENTION

### Field of the Invention

This invention relates to a system for controlling and tracking motorized vehicles. More specifically, this invention relates to a digital interface for operational command of motorized vehicles.

### Description of Related Art

For many construction projects, construction equipment (also referred to herein as “machine(s)” and/or “vehicle(s)”) is supplied to a construction company by a construction equipment rental company. The rental companies are often better suited to maintain the machines and rent the machines to companies of all sizes, but the tracking and managing of unauthorized use of the machines has plagued this industry for decades. Case in point, most heavy construction equipment uses generic or easily obtainable keys to allow easy access to operators at construction worksites. This creates an environment in which unauthorized use of, damage of, and outright theft of equipment often occurs; most often occurring during the night or on weekends when authorized users are not present at a worksite. The resulting damage and loss can include: higher insurance costs, delay in project completion, bill backs by rental companies to customers, lost productivity time finding equipment, potential injury of unauthorized personnel not trained, requesting rental equipment not needed, etc.

In recent years, construction companies have placed location tracking devices on their machines in an effort to recover stolen equipment. While helpful, this mitigates only a portion of the loss incurred. Such trackers do not prevent unauthorized use of the equipment, potentially resulting in damage to the machine, harm to the user or other persons, or damage to the worksite and structures thereon. Therefore, a control system is needed to prevent unauthorized users from turning on the equipment while also providing a means to track the location of stolen equipment

### BRIEF SUMMARY OF THE INVENTION

This invention provides an operating system (also referred to herein as “equipment management system”) that allows a construction equipment rental company and its customers to access information and telematics data through a network. The customer access can be assigned based on which customer is renting that specific machine. The operating system is linked to a device disposed in each piece of construction equipment (“a piece of equipment” may also be referred to herein as “machine”). Such access can be gained through a network portal, that can be accessed through any computer interface or cellular device (mobile, computer, tablet, etc.) capable of connecting to the network. The operating system can use a hi-directional communication system. More specifically, data and messages can be transmitted via an Internet Protocol Network (herein, “IP network”) alone or in combination with Short Message Service message (“herein, SMS message”) or Multimedia Messages Service message (herein, “MMS message”) networks.

### BREIF DESCRIPTION OF THE DRAWINGS

FIG. 1a depicts a communication schematic of the equipment management system, as shown and described herein.

FIG. 1b depicts a communication schematic of the equipment management system having a plurality of ICDs, as shown and described herein.

FIG. 2a depicts a communication schematic of the equipment management system having two communication networks, as shown and described herein.

FIG. 2b depicts a schematic of the equipment management system having two communication networks and a plurality of ICDs, as shown and described herein.

FIG. 3 depicts an example control schematic for a fleet of machines, as shown and described herein.

### DETAILED DESCRIPTION

In some embodiments described herein, all or portions of the electronic computing devices, units, and modules described are implemented in hardware, circuitry, firmware, computer- executable instructions, logic devices, or some combination thereof. Additionally, in the following description, numerous specific details are set forth in order to provide a thorough understanding of the subject matter. In other instances, well-known methods, procedures, objects, ad circuits have not been described in detail as not to unnecessarily obscure aspects of the subject matter.

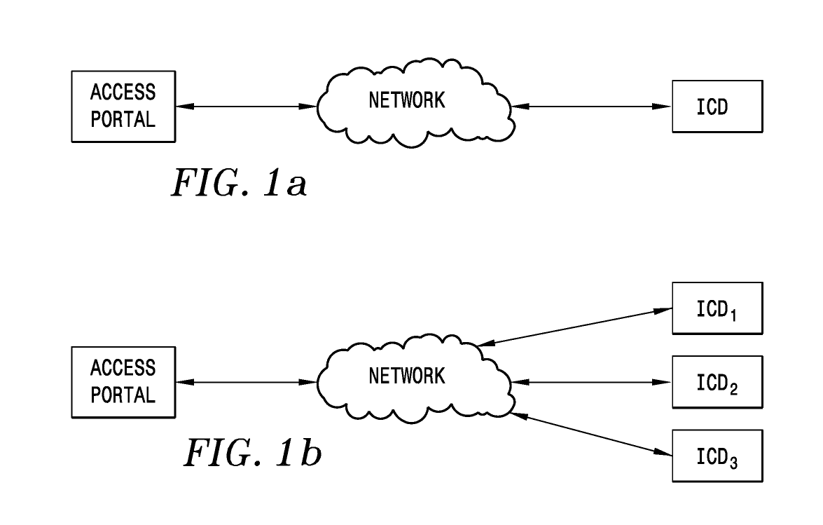

The equipment management system includes various components that support the functions disclosed herein. As shown in FIG. 1a, these components can include one or more Ignition Control Devices (herein, “ICD”), one or more networks, and one or more access portals accessible through one or more user interfaces. Referring to FIG. 1b, the equipment management system

In one or more embodiments, invention can include a wireless data network, an ICD, a host device, a communications server, backend mapping and reporting software (which can include mapping and fleet reporting functions), a programming, updating, and logistics system, a Location Messaging Unit, or any combination thereof

The ICD is disposed on a machine at an appropriate position so that it can connect to and control the machine's ignition. In a preferred embodiment, the ICD is un-detected, or difficult to detect, by an unauthorized user. The ICD preferably includes provisions that allow the vehicle to receive data from various sources and provision that allow the machine to communicate with other machines and/or with the user interface via a signal.

As Shown in FIG. 1a, the equipment management system can include an access portal, a network, and an ICD. The access portal allows a user to communication with the ICD through the network. Referring to FIG. 1b, the equipment management system can. include a plurality of ICDs (three are shown—ICD1, ICD2, ICD3), all or some of which can communicate with a user via the access portal.

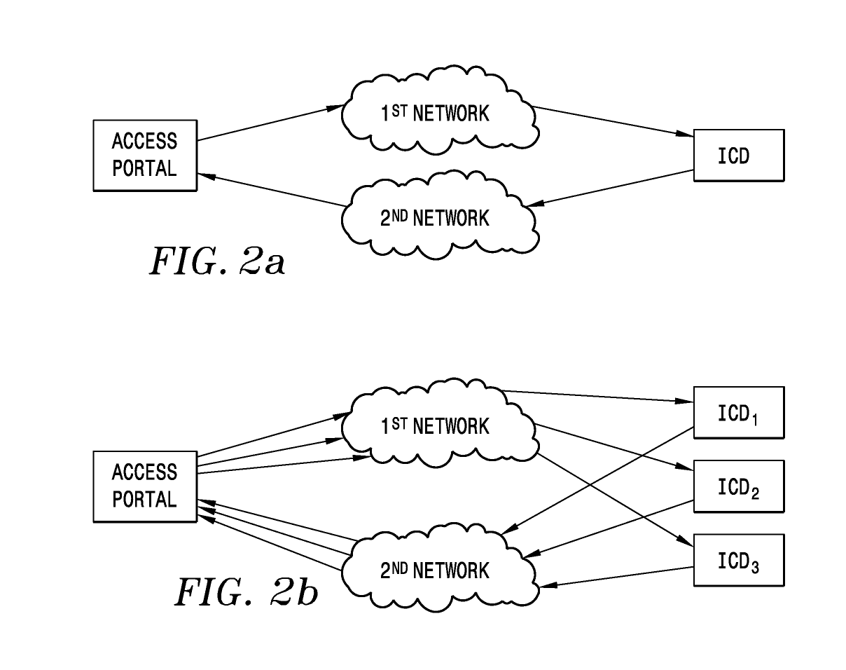

As shown in FIGS. 2a and 2b, the equipment management system can include two or more networks for relay of communication between the user/access portal and an ICD within the equipment management system. In a two-network system, a first selected data type can be communicated through the first network from the user to the ICD(s) and a second selected data type can be communicated through the second network from the ICD(s) to the user. Similar to the equipment management system described in reference to FIG. 1b, the embodiment disclosed in FIG. 2b can include a plurality of ICDs (three are shown—ICD1, ICD2, ICD3).

The ICD can. include a processor and other components to perform computing and communications tasks. The ICD can also include any one or more of the following data transmitting components: an RF antenna, RF connector, a satellite modem, a wireless data modem, a cellular module, and/or a GPS receiver. The ICD can include a one or more external and/or internal inputs, including a digital input, analog to digital input, output, motion sensor input, power state input, battery voltage critical input, high/low temperature input, ignition input, connection to a power supply (including the machine's own battery), or any combination thereof

In at least one embodiment, the ICD can contain hardware and software component, including a direct server, backend software, software applications, programming, updating, and logistics systems, or any combination thereof. the direct server can include a message interface specification detailing the various messages and the content that the ICD can send. The backend software can include a software application having a primary function to parse and present data obtained from the direct server. The software application can then do any of: display location database on reports received from the ICD in a variety of formats, present historic information received from the ICD, typically in a report/chart format, request location updates from one or more ICDs, and/or update and change the configuration of one or more ICDs. the programming, updating, and logistics system can include a web-based maintenance server to manage and perforin configuration and post-installation upgrades. In one or more embodiments, the ICD can be a CalAmp® TTU-1200 series trailer tracking unit. For example, the ICD can be the model TTU-12×0™; the Hardware and Installation Guide of the TTU-12×0™ is hereby incorporated by reference.

The ICD can be configured to transmit data to and from one or more computer devices, via the control portal, across one or more networks. The one or more networks can include any communications medium or protocol, including satellite (e.g. Global Positioning System, herein “GPS”), cellular, and/or wireless data network (e.g., the internet). The system can be implemented using a single communications medium or by using a variety of communications networks configured to facilitate communication between the user interface and the ICDs placed in the vehicles. Each 1CD can contain a cellular modem and a data modem, and each ICD incorporates provisions that allow transmission via the one or more networks.

The user interface includes provisions to receive and process information sent to it by the other components of the system. The user interface can include any computer device able to give a user access one or more networks within the system. Mare particularly, the user interface allows the user to log-in to an access portal to communicate with one or more of the ICDs. Once logged in, the user can communicate with each ICD under the user's control. In most cases, an administrator or rental company will have a web server for storage and transmission of data. In other cases, the administrator or rental company can use an entirely remote system, “cloud based” system, to facilitate data transfer and storage.

A “computer device,” as used herein, can include one or more computer devices, but is sometimes described herein in the singular form for convenience. The computer device can include any electronic device capable of accessing the network, including, but not limited to, a computer (e.g., a desktop computer, a laptop computer), a tablet, and/or a cellular phone. It should be understood that any use of the term “computer device” should be interpreted to mean one or more of any qualifying computer devices.

The equipment management system can also include a listener. The listener can receive communications sent by the ICD, even when a user is not logged-on to the access portal. In one or more embodiments, the listener can initiate an alert to one or more users. These alerts can be useful to a user to know the condition of a machine in real time. In some circumstances, it is especially helpful to a user to receive alerts when the ICD and/or machine is operating incorrectly. For example, alerts can be used to indicate to a user that an unauthorized user has attempted to start a machine, a machine has been mobilized without turning on the ignition, a machine's ICD has been tampered with or has malfunctioned, a machine has been operated for a predetermined period of time outside of its operating window, a machine has been removed from a designated worksite, etc.

The user interface can facilitate one or more access portals. The term “access portal” can include any portal by which a user can access one or more of the networks within the equipment control system. The access portals can allow a user to view or receive data from the ICD as well as send commands to the ICD. Therefore, it may be appropriate to have more than one portal to give specified user type the permission to access data and issue commands.

Through the access portal, a user can access a variety of telematics data as well as access a line of communication with one or more ICDs. As previously discussed, the ICD can use one or more sensors to collect telematics data and then transmit that dated to the user via the access portal. Such sensors can include, but are not limited to: discrete sensors, analog sensors, temperature sensors, motion sensors, door sensors, power failure sensors, voltage/current sensors, propane tank sensors, smoke sensors, etc. Telematics data can include, but is not limited to: operating hours, location, fuel consumed, and odometer reading, speed, engine temperature, or any combination thereof

The user can access a control panel within the user interface and use it to send commands to the ICD. Commands can be entered into a command window by the user. The control panel can allow the user to send commands including, but not limited to: operational window, machine ignition power-on and power-off, ignition relay to prevent an operator from powering on the machine, or any combination thereof. For example, a desktop computer can be a user interface for a user to sign into the administrator portal to send a command to an ICD on a welding machine. In another example, a cellular phone can provide a user interface for a user to sign into the customer portal to send a command to an ICD on a bucket loader.

Some or all of the telematics data and/or command windows can be displayed on a user screen once a user has logged into an access portal on a computer device. In the embodiment described, the access to telematics data and command control panel can be limited based on the access portal through which the user logs on. Multiple access portals can allow a company renting out construction equipment to have total access to the telematics data and control of all machines in its fleet, while having the ability to grant a customer limited access to the telematics data and control of the machines that the customer is renting.

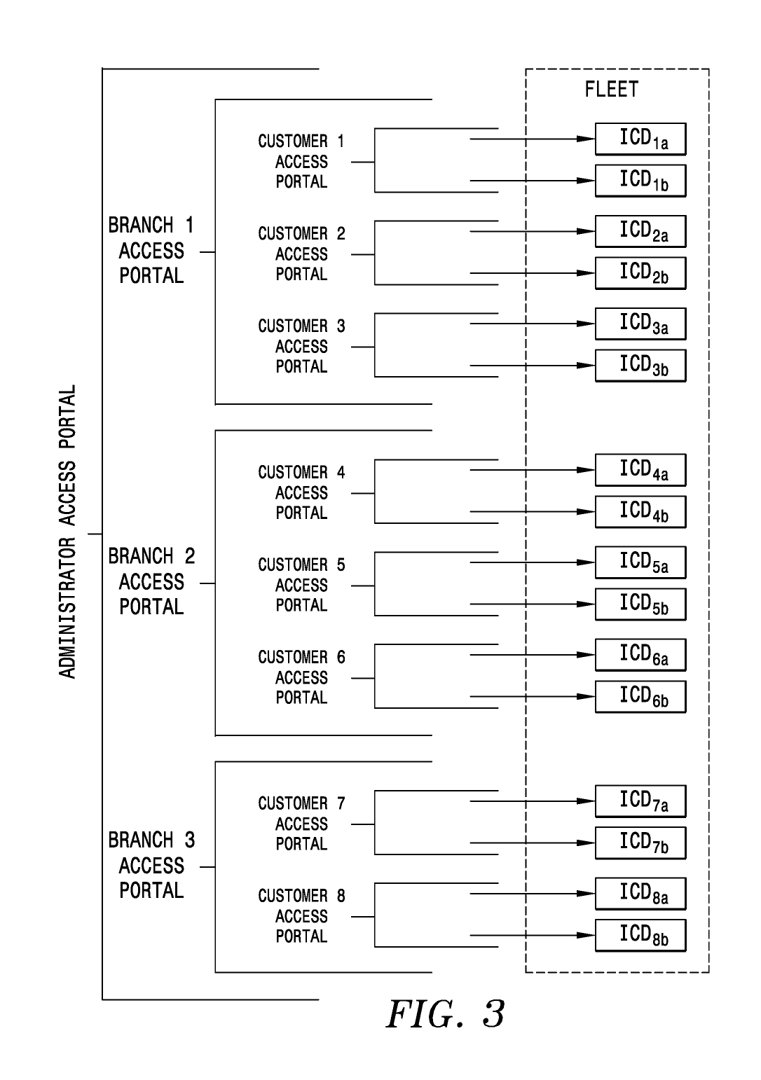

The equipment management system can include a plurality of access portals. As shown in FIG. 3, the access portals can include an administrator access portal, a branch access portal, a customer access portal, or any combination thereof. In one or more embodiments, the equipment rental company can have an administrative office that controls the entire equipment management system, with access to the equipment management system through the administrator access portal. The machines owned by the equipment rental company and equipped with an ICD can be collectively referred to as the equipment rental company's “fleet.”

In one or more embodiments, the equipment rental company may have one or more branch offices and each branch office can manage at least a portion of the rental company's fleet. The branch can have control over all ICDs, including telematic data and command control, within its branch fleet. Accordingly, the branch office can access the equipment management system through the branch access portal. The branch access portal can be configured to give each branch access to the equipment management system limited to those machines under its control.

Customers having an agreement with the rental company can be granted permission for access to the equipment management system for the rented equipment through the customer access portal. Access permission is granted to the customer by either the administrative office or the branch office. For example, Customer 1 can access the ICDs on his rented machines (ICD1a, ICD1b) through the Customer 1 Access Portal. Customer 2 can access the ICDs on her rented machines (ICD2a, ICD2b) through the Customer 2 Access Portal. Customer 3 can access the ICDs on his rented machines (ICD3a, ICD3b) through the Customer 3 Access Portal. A first branch office can manager and access the ICDs (ICD1a, ICD1b, ICD2a, ICD2b, ICD3a, ICD3b) and grant access permissions to Customers 1, 2, and 3, respectively, through the Branch 1 Access Portal. Similarly, a second branch office can manager and access the ICDs (ICD4a, ICD4b, ICD5a, ICD5b, ICD6a, ICD6b) and grant access permissions to Customers 4, 5, and 6, respectively, through the Branch 2 Access Portal. Similarly, a third branch office can manager and access the ICDs (ICD7a, ICD7b, ICD8a, ICD8b) and grant access permissions to Customers 7 and 8, respectively, through the Branch 3 Access Portal. The administrative office can manage and access the ICDs in its fleet (16 are shown, ICD1a-ICD8b), grant access permissions to branch offices 1, 2, and 3, and/or grant access permissions to Customers 1-8.

When the customer is granted access, they can view all job sites under their control, including the identity and data of each machine rented to each of the user's jobsites. This location tracking feature utilizes a twenty-four hour, real-time, GPS based tracking system, and provides the customer with a roadside map view (e.g., Google® map view) of the machine's current location.

With this interactive software, customers can generate a customizable, service schedule for each machine. The controller, ideally the customer, can predetermine and preschedule (days & times) when each machine is enabled/unlocked/awake and/or disabled/locked/asleep. For example, the customers can establish a “definable operation window” in which a back-hoe will be disabled on the weekends during the rental period, beginning Friday at 6:00 pm and continuing through Monday morning at 5:00 am. During that time, the ignition or ignition control device of the back-hoe will be manipulated so that it cannot be turned on. In some circumstances, it may be beneficial to have the defined times be set to at least 1 hour prior and 1 hour after the specific jobsite start and stop working hours.

Once the window is enabled, the unit becomes classified by the inventor as a “smart machine.” The definable operation window can be altered and controlled to accommodate for a variety of factors, including type of machine, jobsite, time, time zone, or day of the week. The customer can also change their “toggle message alert” setting, email address, and phone number.

Once the machine is turned off after the set timeframe for that given day, the ignition cannot be restarted. If someone attempts to start a machine before or after the scheduled hours for that given day, a mobile and/or email notification will be sent to the customer (if their toggle message alert option is on). This notification will include the name or identifier of the machine, jobsite location, and ID number. This feature will also give the customer the option of overriding the lock on the ignition. For example, a unique URL can be sent to the customer with the alert message indicating that an attempt has been made to start the machine and an option allowing the customer to grant permission for the machine to start even though it is not within the machine's defined operation window. In other words, if the customer follows the link and clicks “Yes,” the customer agrees to enable the machine's ignition outside of the window of operation. This message can be sent to the customer as a text message or data text message via the second network, which can be a SMS messaging network. When the SMS messaging network is used in the equipment management system, the user may not be required to log-in to an access portal to communicate with the ICD. Rather, the text message content and/or URL can provide an instant access portal for user to communicate with the ICD. The SMS or texting feature of this invention provides a quick access option for customer to manage ECDs on their rented machines.

In some circumstances, this notification allowing the customer to grant start permission may expire after a period of time (e.g., 2 hours) so that the customer can no longer grant the override. It is an exceptional benefit of this invention to allow the customer to have complete control of each machine he/she is renting.

In some circumstances, it may be beneficial to include an additional feature that prevents the rental company or the customer from turning off a machine that is actively being used. In this case, any equipment used during the allocated hours, may never be turned off while it is operational. Both the customer's and the rental company's administration must wait for the user to turn off the machine before a new command can be implemented. If the customer or the rental company, for whatever reason, wishes to prevent the continued use of their equipment, they can override the reignition of a machine. But, this command will only be performed after the last or current user shuts down the machine.

Not only can customers use this invention for tracking and monitoring rental equipment, but the rental company can have access to the customer's portal so that, when necessary or convenient, the rental company can override the control of a machine. For example, in the event of an emergency, the rental company can remotely re-enable equipment without customer approval. The rental company can maintain control and authorization capacity to an abundance of additional features and commands. For example, the rental company can set up and/or restart the lockdown devices, monitor all the data from either currently rented or unrented equipment, locate any of their equipment across the country, and provide online administrative support.

The rental company can also maintain full control of enabling and disabling any unrented units, at any given time. Once a customer's contract has closed, the rental equipment can be reset to the normal or default setting, “no operational window.”

What is claimed is:

1. An equipment management system, comprising:
an ignition control device for connecting to a vehicle;
a network for transmitting data between the ignition control device and a computer device;
an administrator portal to access the network, wherein an administrator can grant limited access to the data network through a customer portal.

2. An equipment management system, comprising:
an ignition control device for connecting to a vehicle;
an administrator portal for receiving data from the ignition control device across a first network,
wherein the administrator portal is accessible through a computer device,
wherein a command can be transmitted to the ignition control device through a second network, and
wherein access to the first and second networks can be granted to a customer through a customer portal.

3. An equipment management system, comprising:
a vehicle having an ignition control device connected thereto;
an IP network for transmitting data from the ignition control device to a user interface;
a service network for transmitting commands from a user interface to the ignition control device;
an administrator portal to access the network, wherein an administrator can grant limited access to the data network through a customer portal.
